(19) United States
(12) Patent Application Publication
(10) Pub. No.: US 2015/0296207 A1
(43) Pub. Date: Oct. 15, 2015

(54) Method and Apparatus for Comparing Two Blocks of Pixels

(71) Applicant: Vincenzo Liguori, North Manly (AU)

(72) Inventor: Vincenzo Liguori, North Manly (AU)

(21) Appl. No.: 14/750,942

(22) Filed: Jun. 25, 2015

Related U.S. Application Data
(63) Continuation of application No. PCT/AU2014/000006, filed on Jan. 8, 2014.

(51) Int. Cl. H04N 19/124; H04N 19/182; H04N 19/176; H04N 19/139; H04N 19/172

(52) U.S. Cl. CPC H04N 19/124; H04N 19/139; H04N 19/172; H04N 19/176; H04N 19/182

(57) ABSTRACT

A method for operating a data processing system to compare a first block, B₁, of pixels in a current frame to a second block, B₂, of pixels in the reference frame is disclosed. First and second signature vectors, V₁ and V₂, respectively, are generated for the first and second blocks. The distance between first and second signature vectors using a distance function D(V₁,V₂) is measured to provide a comparison of the similarity of the blocks. The signature vectors are chosen such that D(B₁,B₂)<D(B₁,B₃) then D(V₁,V₂)<D(V₁,V₃), where B₃ is a third block of pixels in the reference frame. In addition, the computational workload of comparing the two blocks, on average, using the signature vectors is less than that imposed by directly comparing the blocks.

This is a continuation under 35 U.S.C. 111(a) of PCT application PCT/AU2014/000006 filed on 8 Jan. 2014, said PCT application claiming priority from Australian Provisional Application 2013900077, filed on Jan. 9, 2013, which is hereby incorporated by reference.

### BACKGROUND

A number of problems in image recognition and image compression rely on comparing two blocks of pixels taken from different images. For example, in video transmission and compression schemes the redundancy between successive frames is utilized to reduce the bandwidth and storage requirements of the video. In block motion prediction schemes, each frame is divided into a plurality of fixed size blocks. A frame to be transmitted is first coded in terms of blocks of a reference frame that has already been sent by finding the block in the reference frame that most closely matches the corresponding block in the current frame. The current block is then represented as the block in the reference frame plus a difference block. If the reference block is a close match to the current block, the difference block will have substantially less information, and hence, can be coded using a lossy high compression image compression scheme that still allows the current block to be reconstructed at the receiver to the desired accuracy.

Similarly, in image recognition systems, blocks of pixels from an object in a library must be compared to blocks of pixels in the image to determine if the library object is in the image. Again, the block of pixels from the library object must be matched against similar sized blocks at a number of locations in the image to determine whether the object is in the image and the location of that object within the image.

Finally, in stereoscopic vision systems, blocks of pixels from one view must be compared to blocks of pixels from a second view to identify an object that is present in both views and determine the three-dimensional location of the object.

Two commonly used algorithms for measuring the similarity between two blocks of pixels compute either the sum of the absolute values of the differences of the pixels or the sum of the square of the differences of the pixels. The computational workload in comparing two n×n blocks of pixels using these algorithms is of order n². If the image being processed is an N×N array of pixels, the matching process must be repeated roughly (N−n)² times to find the corresponding block in the second image that corresponds to the current block in the first image. Hence, this type of correlation comparison is typically limited to relatively small block sizes, because of the rapid increase in computational workload with n or the search area must be limited by some other mechanism.

### SUMMARY

The present invention includes a method for operating a data processing system to compare a first block of pixels, B₁, in a current frame to a second block of pixels, B₂, in the reference frame. The method includes generating first and second signature vectors, V₁ and V₂, respectively, for the first and second blocks. The distance between first and second signature vectors using a distance function D(V₁,V₂) is measured to provide a comparison of the similarity of the blocks. The signature vectors are chosen such that D(B₁,B₂)<D(B₁,B₃) then D(V₁,V₂)<D(V₁,V₃), where B₃ is a third block of pixels in the reference frame and such that computing D(B₁,B₂) imposes a first computational workload on the data processing system and computing D(V₁,V₂) imposes a second computational workload on the data processing system. The sum of the computational workload imposed by generating V₁ and V₂ on the data processing and the second computational workload are, on average, less than the first computational workload.

In one aspect of the invention, generating the first signature vector includes transforming the first block using a linear transformation to generate a component of the first signature vector. The component preferably measures a power in a portion of the first block in spatial frequencies that are less than a first spatial frequency limit. One of the components of the signature vector could also be chosen such that the component measures a power in a portion of the first block in spatial frequencies in a first spatial frequency band having a low-spatial frequency cut-off greater than zero.

In another aspect of the invention, the linear transformation is a wavelet transformation.

In another aspect of the invention, a third signature vector, V₃, for a third block in the reference frame is generated. The third signature vector is generated by updating the second signature vector. The data processing system compares the distance between the first and third signature vectors with the distance between the first and second signature vectors to determine which of the second and third blocks is a better match to the first block.

In a still further aspect of the invention, the reference frame includes a plurality of rows and columns of pixels and wherein the third block is located on the same row or column of the reference frame as the second block and has pixels in common with the second block.

### BRIEF DESCRIPTION OF THE DRAWINGS

FIG. 1 illustrates the matching of blocks between a current frame and a reference frame.

FIG. 2 illustrates an apparatus for the matching of one block in the current frame to a sequence of blocks in the reference frame.

FIG. 3 illustrates the transformation of an image using a two-dimensional wavelet transformation.

FIG. 4 illustrates the transformation of an image block using the class of wavelet transformation discussed with respect to FIG. 3.

FIG. 5 illustrates a video compression engine according to one embodiment of the present invention.

FIG. 6 illustrates an engine for performing stereo disparity matching.

### DETAILED DESCRIPTION OF THE PREFERRED EMBODIMENTS OF THE INVENTION

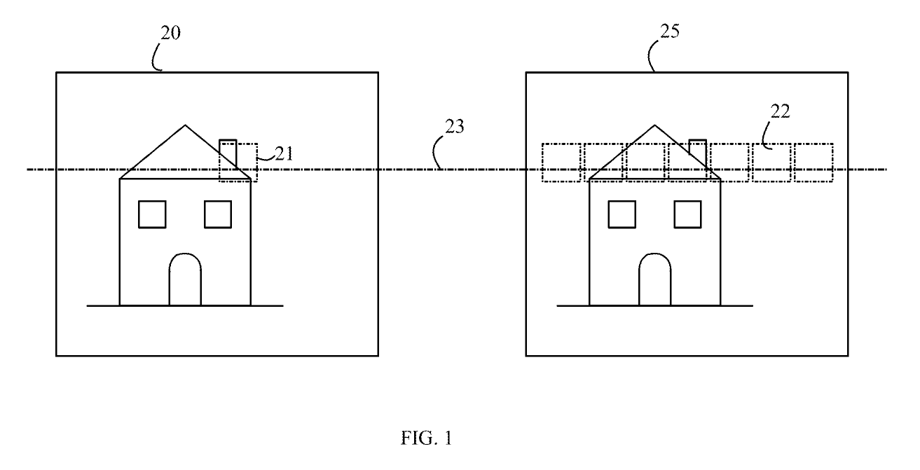

The present invention can be more easily understood in terms of the problems encountered when an n×n block of pixels in a first frame, referred to as the current frame, is to be matched against all of the possible blocks of the same size within some target region in a second frame, referred to as the reference frame. Refer now to FIG. 1, which illustrates the matching process in question. The current frame is shown at 20. A block of pixels 21 in current frame 20 is to be matched against a plurality of target blocks in reference frame 25. A typical target block is shown at 22. While the target blocks are shown as non-overlapping to simplify the drawing, it is to be understood that in general the sequence of target blocks overlap one another, typically being displaced from one another by a distance of one pixel in the image. While the example shown in FIG. 1 has the target blocks being shifted along the same horizontal line, it is to be understood that in the more general case, the target blocks may be shifted with respect to one another in both the horizontal and vertical directions.

Here, it is assumed that the images are N×N pixel images, where N>>n. The computational cost of such a search is approximately N²C_{b}(n) if the entire reference frame is searched. Here, C_{b}(n) is the computational cost of comparing two single n×n blocks. As noted above, comparisons that measure the correlation between the blocks such as those that utilize a sum of differences of corresponding pixels in each block have a cost that is proportional to n². Hence, to reduce the computational workload, small values of n are often used, e.g., n=16.

In general, there is some optimum sized block that can be matched between the two frames that depends on the specific application. If a block is too small, it will match a number of different blocks in the current frame and the match can be negatively impacted by the presence of noise. At the other extreme, a large block may not match any block in the reference image as the scene may have changed sufficiently to make such a match impossible. Between these two extremes, there is a block size that is big enough to be immune from noise and reduce the chance of accidental matches and still be small enough to have a good probability of finding a corresponding block in the current frame even when part of the frame has changed due to the motion of an object between the times corresponding to the reference and current frames. The computational workload constraints imposed by using direct correlation methods such as those described above can result in the blocks being too small.

The present invention reduces the average computational workload in comparing a block of pixels in the current frame with a sequence of target blocks in the reference frame by defining a signature vector that represents each of the blocks to be compared. The comparison is then carried out on the signature vectors rather than the corresponding blocks of pixels. In the present invention, the number of components in the signature vector is much smaller than n², for an n×n block. Hence, the cost of comparing the two signature vectors is substantially less than the cost of comparing the two blocks in the prior art scheme. However, to provide an improvement over the prior art, the signatures of the present invention should satisfy two additional conditions.

Denote a function that measures the difference between two vectors by D(V₁,V₂), where V₁ and V₂ are the two vectors. This function will be referred to as the distance function in the following discussion. For example,

D(V₁,V₂)=Σₜ^{Nv}|V₁(i)−V₂(i)|, (1)

where Nv is the number of components in each vector. To simplify the following discussion, this particular function will be assumed unless otherwise indicated. However, it is to be understood that there are a number of different functions that could be used to measure the difference between two vectors. For example, a distance function that sums the square of the difference between the components of the vectors is also commonly used to measure the distance between two vectors. Denote the signature vector representing a block B by V(B).

Consider a block, B₁, in the current frame that is to be matched to two blocks, B₂ and B₃ in the reference frame. First, the signature vector that represents a block must be a good proxy, on average, for that block. That is, if the distance function applied directly to the blocks satisfies the constraint D(B₁,B₂)<D(B₁,B₃) then, on average, D(V(B₁),V(B₂))<D(V(B₁),V(B₃)).

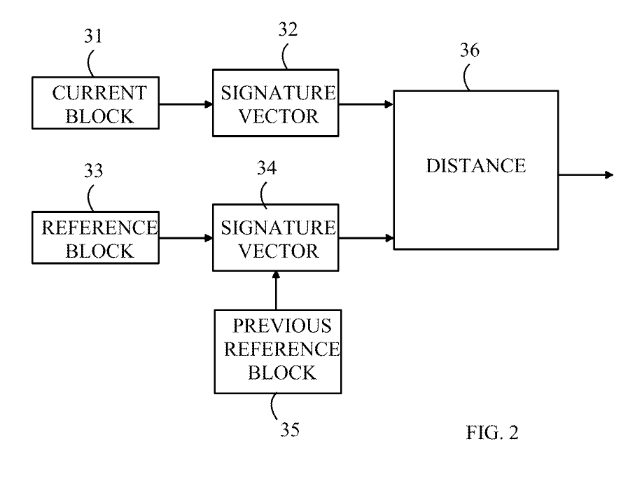

Second, the average computational workload in comparing a block in the current frame to all possible blocks within the search area of the reference frame must be less than the workload of comparing the blocks directly. Refer now to FIG. 2, which illustrates the matching of one block in the current frame to a sequence of blocks in the reference frame. Initially, a signature vector representing the current block 31 is generated as shown at 32. Signature vector 32 only has to be computed once for the entire sequence of blocks that are to be tested in the reference frame with respect to that block. Hence, the workload in generating that signature vector can be amortized over all of the target block comparisons in the reference frame, and does not impose a significant computational workload on the process. For each target reference block 33 in the reference frame, a signature vector 34 must be generated.

There are a number of signature vector definitions that utilize only a small portion of the block of pixels, and hence, can provide the required reduction in computational workload. For example, a signature vector that has each component generated by the sum of a few pixels at predetermined locations in the block can provide a component of a signature vector that is computationally inexpensive and is less subject to noise than just selecting a sub-group of pixels. As long as the total number of pixels that must be added to provide all of the components of the signature is significantly less than n², the second requirement can be satisfied.

In addition, as will be explained in detail below, the workload needed to generate a signature for a block can be significantly reduced for some choices of signature vector by using a signature vector computed for a previous block as shown at 35. For example, consider an n×n block of pixels having a base address of (tₓ,t_{y}) in an image represented by an array, I_{x,y}. Define an n-component signature vector for this block in which the i^{th} component of the signature vector, Vᵢ(tₓ,t_{y}), is just the sum of the pixel values in the column of pixels at the i^{th} column of the block. That is,

$${V}_{i} ( {t}_{x} , {t}_{y} ) = {\sum }_{j = 0}^{n - 1} {I}_{{t}_{x + 1} , {t}_{y + j}} , \qquad ( 2 )$$

for i=0 to n−1. The signature vector for the block located at (tₓ₊₁,t_{y}) has components given by

Vᵢ(tₓ₊₁,t_{y})=Vᵢ₊₁(tₓ,t_{y}), (3)

for i=0 to n−2 and

$${V}_{n - 1} ( {t}_{x + 1} , {t}_{y} ) = {\sum }_{j = 0}^{n - 1} {I}_{{t}_{x + 0} , {t}_{y + j}} . \qquad ( 4 )$$

Hence, the signature vector for the next block is merely the previous signature with the components of the previous signature vector shifted and the last component being replaced by the sum of the pixels in the new column that is introduced by shifting the block one pixel. If the components of the signature vector are stored in a circular buffer, the shift operation can be performed by changing a pointer in that buffer. Hence, the work to generate the new signature vector is essentially the n additions needed to sum the pixels in the new column. The work to compare the two signature vectors is proportional to n. Hence, the workload to compare the blocks using the signature vector method of the present invention is of order n, as opposed to the work to compare the blocks directly which is of order n².

Once the two signature vectors are generated, the distance between them is computed by a processor as shown at 36. The minimum value of the distance is stored in the processor together with the location of the block in the reference frame that generated that minimum.

In another aspect of the invention, the components of the signature vector are derived from the transform coefficients of a linear transformation of the block of pixels. The above described column summing algorithm is an example of such a linear transform. Transforms used in image compression algorithms are also linear transformations and provide additional benefits. In a conventional image compression algorithm, a picture is compressed by first fitting the picture to an expansion using a set of two-dimensional basis functions. The particular set of basis functions depends on the particular image compression algorithm. The coefficients of the basis functions in the expansion become the “pixels” of the transformed image in image compression.

Define the “energy” in a block of pixels by the sum of the square of the pixel values over the block. The image transform concentrates the energy in the image into a sub-set of the pixels of the transformed image. That is, the total energy in this sub-set per pixel, on average, is greater than the average energy per pixel in the original image (i.e., the sum of the squares of the pixel intensities divided by the total number of pixels in the original image). The present invention is based on the observation that the transformed pixels having the most energy are also good candidates for constructing a signature vector. Such transformed pixels are less affected by noise and represent the information of interest to a human observer. In general, the image compression transforms can be viewed as providing a plurality of transformed images representing different spatial frequencies in the image. In one aspect of the present invention, a subset of the transformed “pixels” from the transformed images having different spatial frequency bands are used to construct the signature vector for a block of pixels.

In general, the transformations used in image compression are reversible. That is, the picture can be recovered by summing the basis functions multiplied by the coefficients provided the original coefficients were computed to sufficient accuracy. Significant image compression is obtained by approximating the transform coefficients which introduces errors into the reconstructed image. In the present invention, there is no need to reconstruct an image from a signature vector representing a block, and hence, the present invention can utilize transforms or approximations that would not provide a reconstruction of the image. The transform is used to concentrate the information of most interest in the picture into a sub-set of the transform coefficients, which are then provided with a better approximation than those associated with information of less interest to a human observer. The present invention utilizes the observation that the pixels of the transformed image of a block of pixels in which the information that is of most interest to human observers are also likely to be pixels that are good candidates for generating components of a signature representing a block of pixels.

In image compression applications, all of the coefficients of the transformed image must be calculated. However, in the present invention, only the coefficients that are being used to compute a component of a signature vector need be computed. Hence, the computational workload to compute the coefficients is substantially less than that needed to transform an entire image prior to approximating the coefficients. In addition, as will be explained in more detail below, a transformation that allows a coefficient of interest to be computed for successive blocks of pixels that are offset with respect to one another by updating the previously computed coefficient rather than computing the coefficient directly from the pixels of the new block can further reduce the computational workload.

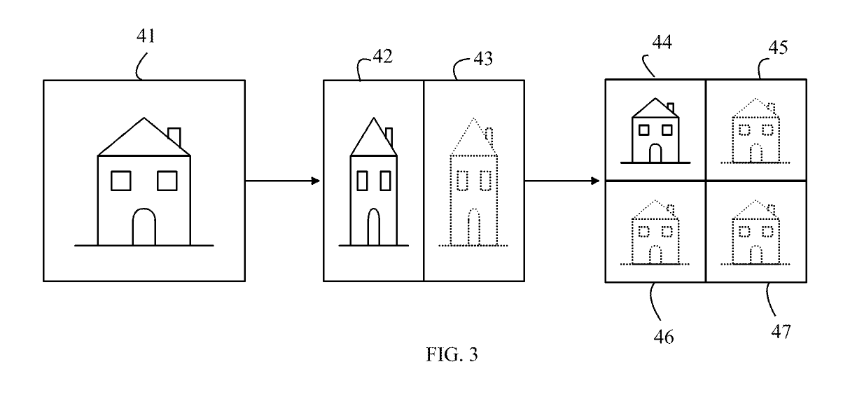

One class of image compression algorithms utilizes a set of basis functions that are referred to as wavelets. In a wavelet transformation of an image, the original image is transformed in a number of transformed images that represent the information in various spatial frequency ranges in different portions of the image. The transformation of the image is typically performed by filtering the rows and columns of pixels using a plurality of filters. In the simplest case two filters are used. The first is a low-pass filter that emphasizes the low spatial frequencies and the second is a high pass filter that emphasizes the high spatial frequencies of the image. Refer now to FIG. 3, which illustrates the transformation of an image using a two-dimensional wavelet transformation. The transformation is normally performed by first filtering the horizontal lines of pixels of the original image 41 with the two filters to create two sub-images 42 and 43, each having half the number of pixels. Sub-image 42 emphasizes the low spatial frequencies in the horizontal direction, sub-image 43 represents the high spatial frequencies in the horizontal direction. Since the edges of objects have high spatial frequencies, sub-image 43 resembles a map of the edges in the original image that are crossed by moving in a horizontal direction. Each of these sub-images is again filtered by filtering the columns of pixels in each sub-image through the two filters to arrive at the four sub-images shown at 44-47. Sub-image 44 emphasizes the low spatial frequencies, and the remaining sub-images emphasize edges with different orientations.

The “pixels” in the various sub-images are actually coefficients of a fit to the original image using two-dimensional basis functions. The specific basis functions depend on the details of the wavelet transform, which, in turn, determine the filter coefficients of the filter used to process the rows and columns of pixels. Since the transforms are linear in nature, it is sufficient to note that any “pixel” in the transformed image can be obtained from a weighted sum of pixels in the original image.

For orthogonal transformations, it can be shown that any given image coefficient, i.e., “pixel” in the transformed image, can computed from a formula of the form

A_{i,j}=Σ_{m,n}I_{m,n}w_{i,j,m,n} (5)

Here, the parameters w_{i,j,m,n} are weight factors that depend on the particular transformation. While (m,n) vary over the entire image, the transformation can be chosen such that the weight factors are only non-zero for a small number of pixels for each coefficient of interest. The reduction of the computational workload to only a small number of pixels per coefficient can be further improved by setting some weight factors to zero. While such an approach would not be permitted in an image compression context, for the purposes of generating a signature, such approximations can provide an adequate signature for comparing two blocks of pixels, while further reducing the computational workload.

As noted above, the matching process involves matching a block in the current frame to a number of different blocks in the reference frame. The blocks in the reference frame are displaced from one another, usually by an offset of one pixel. Consider the case in which the weight factors are either 1 or 0. The example given above in which the block of pixels was transformed by adding the pixels in each column is an example of such a transform. Similarly, the low frequency filter used to implement a wavelet transform using the Haar basis functions satisfies this constraint. The high frequency filter in the Haar basis has the property that the coefficients are 0, 1, or −1.

Consider the case in which a component of the signature vector is computed from a coefficient in the transformed image using a transformation in which the non-zero weight factors are all the same. To simplify the notation, the coefficient in question when computed for a block at location t=(tₓ,t_{y}) can be written in the form:

A(t)=K*Σ_{m,n}I_{m,n}w_{m,n}(t) (6)

where K is a constant, and the w_{m,n} (t) are either 1 or 0. The values that are non-zero are constrained to a block of pixels in the image having a location that is determined by t. Consider a block (t+1) that is displaced from block t by one pixel to the right in the current image. The block of pixels in the original image corresponding to this block has the same size but is displaced by one pixel to the right. This block of pixels in the original image differs from the block t by two columns of pixels. That is,

A(t+1)=A(t)+K*(Cₙ₊₁−C₁) (7)

where Cₙ₊₁ is the sum of the pixels in the new column of pixels that are included in block (t+1) and C₁ is the sum of the pixels in the column of pixels in block (t) that is not included in block (t+1). If the sum of the columns is saved from block to block, the successive signatures can be computed by updating the previous coefficient by the sum of the new column of pixels. This operation has a computational complexity that is linear in the size of the block of pixels in the original image that determines the coefficient of the signature vector.

In this example, the component of the signature vector was computed from a low spatial frequency component of a Haar-based transformation of the original image. However, signature components can also be based on high frequency pixels in the transformed image. In this case, the component can still be written in the form shown in Equation 6; however, the w_{m,n}(t) can now also have a value of −1. The component for the (t+1)^{st} block can still be written in the form of a correction to the component for block (t); however, additional columns must now be added and subtracted from A(t).

While a component of a signature vector could be a transform coefficient of the type discussed above, it is often advantageous to reduce the number of bits needed to represent that component. The computational workload and computational hardware needed to compute the distance between two signature vectors depends on the form of the components (integer, floating, etc.) and the number of bits needed to represent the component. Integer arithmetic can be carried out in less expensive hardware than floating point arithmetic, and a computation can be completed in less time. Hence, integer signature vector components are preferred. In addition, components that require smaller integers to represent the component are preferred. It should be noted that the transform computations can be carried out in parallel on a computing platform that supports multiple cores. Thus reducing the computational workload can also improve the overall speed of matching, which can be important in real-time applications.

It should be noted that transforms that utilize non-zero weight functions having values that can be represented by ±1 are preferred, as such transforms can be carried out in integer arithmetic, since the pixel values used in most image representations are integers. It should be noted that any transform in which all of the weights are ±C, where C is a constant can be computed using weights of ±1 followed by multiplication by C. Furthermore, as will be explained in more detail below, the multiplication by C can be included in the computations used to approximate the transform coefficient during quantization of the coefficient.

Even with the use of the transforms discussed above, the number of bits needed to represent a transform coefficient can be much greater than the number needed to match blocks using a signature vector. Consider an image having 12-bit pixel values. If the transform adds 16 pixels together to arrive at the transform value to be used as a component of a signature vector, the component could require 16 bits to represent. In a transform that uses weights that are ±1, the transform coefficient could be negative as well as positive. Arithmetic based on 8-bit integers would require less computational hardware. The number of bits can be reduced by quantizing the transform coefficient to arrive at the component of the signature vector. The quantization maps the values obtained by the transform to an integer within some predetermined range. In the above example, the 16-bit representation of the transform coefficient could be mapped to an 8-bit integer. If the transform coefficient is represented by a 16-bit signed integer, the quantization can be implemented by shifting bits off of the integer while preserving the sign bit. Hence, the computational work involved quantizing the transform coefficient is small compared to the workload of generating the transform coefficient.

Signature vector components can also be constructed by combining transform coefficients. For example, a signature coefficient can be constructed from a weighted sum of two or more transform coefficients of the type discussed above. It should be noted that any linear function of transform coefficients can be expanded to obtain a new transform coefficient that satisfied Equation 5 discussed above.

The number of bits needed to represent a signature vector component after quantization can be further reduced by using entropy coding of the component. Entropy coding is a loss-less compression scheme in which the quantized values are replaced by codes having different numbers of bits. The quantized values that are used the most are assigned codes that have fewer bits than the quantized values that appear less frequently.

The quantization process can also be applied at the signature vector level. That is, the range of signature vectors obtained from the transform coefficients can be mapped to a predetermined set of vectors having fewer possible vectors. The quantized vectors are then used in the block matching algorithm. Each signature vector can be viewed as representing a point in an Nᵥ dimensional space. In vector quantization, a set of lattice points are defined in the space. The signature vector is then replaced by the lattice point that is closest to that vector. The set of quantized vectors can be mapped to a set of codes to further reduce the bits needed to specify the quantized vectors. The quantized vectors can then be stored in a separate memory and retrieved via the codes. The computational workload in generating the set of lattice points and determining which lattice point most closely approximates a signature vector can be excessive in the general case, as the optimum set of lattice points depends of the distribution of possible signature vectors.

The computational workload in performing vector quantization can be reduced by Pyramid Vector Quantization. Since this type of quantization is known to the art, it will not be discussed in detail here. The reader is referred to T. R. Fisher, “A Pyramid Vector Quantizer”. IEEE Transactions on Information Theory, vol. IT-32, NO. 4. July 1986 for a more detailed discussion. For the purposes of the present discussion it is sufficient to note that this method provides a predetermined set of lattice points that are well matched to the coefficients generated in image transforms. The method operates on normalized vectors and assigns each vector to one of a predetermined set of lattice points, each lattice point having a unique identifier. Given a normalized vector, the method provides the identifier, and conversely, given an identifier, the method will return a normalized vector. Whether the additional workload of performing vector quantization provides a significant improvement over just measuring the distance between the signature vectors representing each block depends on the specific application.

It should be noted that the identifiers are analogous to the codes generated by pyramid vector quantization algorithms. The advantage of these identifiers lies in the ease of decoding the coded vectors that results from all of the identifier codes having the same length. The codes provided by entropy encoding are of varying lengths, and hence, complicate the decoding process.

Pyramid vector quantization schemes generate normalized vectors, and hence, the normalization can be used as a separate component of the final vector or just the normalized vectors can be compared. The normalized vectors can be useful in matching problems in which the different images have different illumination levels.

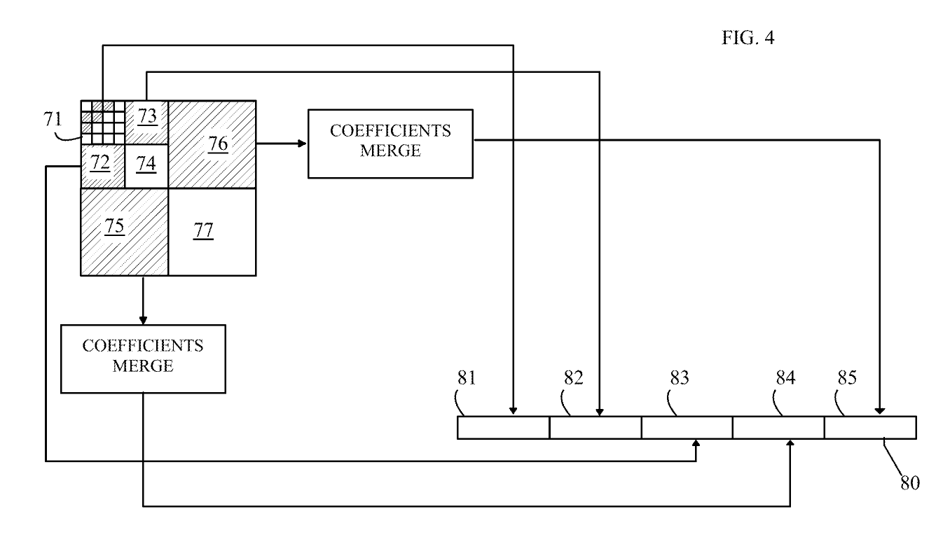

As noted above, the signature components can be generated starting from a linear transformation of the image block being matched. Refer now to FIG. 4, which illustrates the transformation of an image block using the class of wavelet transformation discussed above with respect to FIG. 3. In the case shown in FIG. 4, the low frequency transform coefficients are again transformed using the same pair of filters so that the final transformed image has the seven “sub-images” shown at 71-77. The sub-images shown at 75-77 are the high spatial frequency sub-images created by the first application of the wavelet transform. The sub-images shown at 71-74 are the sub-images created by processing the original low spatial frequency sub-image a second time. Hence, sub-image 71 is the low spatial frequency coefficient for the block and the remaining sub-images are various high-spatial frequency coefficients that have information of less value to human observers. Several of the “pixels” from the low spatial frequency sub-image are selected to be components of the signature vector 80 as shown at 81. Similarly, one or more coefficients from the high-spatial frequency sub-images 72 and 73 are also selected for components of signature vector 80 as shown at 82 and 83. The pixels can be combined to reduce the number of components in the signature vector. Similarly, coefficients from the high spatial frequency components 75 and 76 are also combined to form components of signature vector 80 as shown at 84 and 85. The components can be computed from any function of the pixels in question. Linear combinations, however, are preferred to reduce the computational workload. The components of the signature vector can be reduced further by quantizing the individual components or quantizing the vector as discussed above.

For example, consider a case in which an 8×8 block of pixels in the current image is to be matched against a series of 8×8 blocks in the reference image. If a two level Haar decomposition of each image is used, the low spatial frequency region shown at 71 will have four coefficients. The two high spatial frequency regions shown at 72 and 73 will also have four coefficients. In one embodiment, the four coefficients from sub-image 71 are selected as components of the signature vector. In addition, two components are generated from high-spatial frequency sub-image 73 by adding together the components in two 2×2 areas of this region. Similarly, two additional components are generated from high-spatial frequency sub-image 72 by adding together the components in two 2×2 areas of that region. The resulting signature vector has eight components. The components can be reduced further by quantizing each of these eight components. If the components are held in integer registers, the quantization can be performed by a simple shift operation on the registers. More complex quantization schemes can also be employed.

While the generation of the signature vector has been described in terms of a two level Haar transform of the type used in image compression systems, the entire 8×8 starting block does not need to be subjected to the Haar transforms. The Haar transform is a linear transform, and hence, the coefficients of the compressed image need not all be computed. The selected coefficients can be written in terms of the transformation of the original image in the form given above in Equation 5. In the case of the Haar transform, the weight coefficients can be chosen such that all of the coefficients have absolute values of 1 or 0. It should also be noted that the combined coefficients from high-spatial frequency sub-images 72 and 73 can be computed directly using a relationship of the form shown in Equation 5, as the addition is also a linear operation. It should also be noted that the signature vector for a block that is displaced by one pixel from a previous block for which the signature vector is known can be computed by updating the previously computed signature vector, which further reduces the average computational workload in generating the signature vectors for successive blocks in the reference image.

Since the signatures do not need to be of an accuracy that would allow the image block to be reconstructed therefrom, the number of bits that are used to represent each component of a signature vector can be chosen to minimize the total number of bits in the signature vector. As long as the signature vector satisfies the constraints discussed above, the designer is free to set the number of bits per component to optimize other design criteria. In this regard, it should be noted that the computations involved in measuring the distance between two signature vectors can be run in parallel on special purpose hardware. The difference between one pair of corresponding components in the signature vectors does not depend on the difference between any other pair, and hence, these computations can be done in parallel. One form of special purpose hardware comprises a programmable gate array for constructing the engine that computes the difference between the two signature vectors. The number of gates needed to compare a pair of components is determined by the number of bits used to represent the components. Hence, minimizing the number of bits required to represent each component allows fewer gates to be utilized in the special purpose hardware, and hence, reduces the cost of the special purpose hardware.

If the signature block distance calculations are being performed on a general purpose computer, it is advantageous to chose a signature vector that is optimized for vector computations on that computer. For example, a single hardware instruction that computes the distance between two vectors having eight or 16 components in which each component is eight bits is available on a number of general purpose computers. In this case, reducing the components below eight bits does not provide a significant advantage.

As noted above, the problem of matching a block in a current frame against a number of blocks in a reference frame occurs in a number of important applications. In the case of motion estimation inter-predication, the block in the reference frame that is the best match for the block in the current frame does not need to be from the same object in the two frames. Given a sequence of two frames that are of the same scene in which a plurality of objects are present, the purpose of the block matching is to provide an approximation to the current block that can be sent to the receiver. That approximation is subtracted from the current block to produce a remainder block that can be compressed with fewer bits than would be needed if the original block were compressed and still provide the desired level of accuracy in the reconstructed image at the receiver. The optimum block size is the size that minimizes the bits that must be transmitted to reconstruct the image.

It should be noted that the approximation block in an inter-prediction scheme need not be the corresponding block to the current block in the reference frame image. Consider two frames of the same scene, and denote the location of the current block in the current frame by (x₁,y₁). In the absence of noise or changes in the scenes between frames, it would be expected that the best match for this block in the reference frame would be the block at (x₁, y₁). However, because of noise or changes in the scene, the best match to the current block might be at (x₂,y₂). Since the compression scheme only uses the best block match as an approximation to the current block, it does not matter that the blocks are not corresponding blocks in the two frames.

In contrast, in stereo disparity matching, two frames taken at the same time from cameras that are displaced from one another and which view the same scene, are processed to provide a three-dimensional reconstruction of the scene. In this case, the matching algorithm attempts to identify an object on the current frame with an object in the reference frame by matching a block of pixels in the current frame to a plurality of blocks in the reference frame. The blocks must be big enough to ensure that the matching blocks represent the same part of the same object. The present invention is particularly well suited for such matching. Refer again to FIG. 1. In stereo disparity matching, the block of pixels shown at 21 is matched against a sequence in reference frame 25 that is located on the same horizontal scan line 23. That is, it is assumed that the cameras are at the same elevation relative to the scene. Hence, the sequence of blocks to be matched differ from one another by one pixel in the horizontal direction.

Consider the case in which the signature vector for each 8×8 block is derived from a two level Haar transform as shown in FIG. 4. In this case, there will be four low-spatial frequency coefficients in the transformed image at 71. In addition, there will be three blocks of four high spatial frequency coefficients at 72-74. In this example, a signature vector for a block is constructed by using the four low-spatial frequency components as the first four components of the signature vector and four high spatial frequency components from high-spatial frequency sub-images 72 and four high spatial frequency components from region 74 to provide a 12 component signature vector. Each component of the signature vector requires that four pixels in the original image be added or subtracted. Since an add and a subtract impose the same computational workload, these operations will be referred to as “adds” in this example. Hence, the cost of generating a signature vector is of the order of 48 adds if the weights in Equation 5 all have the same absolute values. In the general case, the weights would not have the same absolute values, and hence, 48 adds and 48 multiplies would be needed.

The signature vectors for each block in the reference frame on a given horizontal line need only be computed once. Similarly, the signature vectors for each block in the current frame need only be computed once. Assume that there are M blocks in each frame. The computational workload to compute the 2M signature vectors, is 2M*48 adds. The work to compare each block in the current frame to each block in the reference frame is M²*C, where C is the cost of comparing two signatures. If the sum of the absolute differences is used, C is of the order of 48 adds (one add to form the difference and one to sum the absolute value of the components). Hence, the cost of using the signature vectors of the present invention is approximately 48 M²+48 M adds. If the blocks in question were matched using the prior art methods, the cost of comparing two 8×8 blocks is 128 adds. The cost of matching all of the blocks is 128 M². Hence, even for 8×8 blocks, the signature vector approach of the present invention is significantly less computationally intense. As the size of the blocks increases, the difference is even more significant.

The optimum block size for stereo disparity matching must be sufficient to ensure that two blocks from different objects in the scene do not inadvertently match one another. As noted above, the computational workload to match blocks using the direct block matching algorithms increases as the square of the block size. Hence, the direct method is often limited to sub-optimum block sizes. In contrast, in the present invention, the size of the signature vector does not necessarily increase at this rate with the size of the block, and hence, the present invention can work with much larger blocks.

As noted above, the present invention can also be utilized in motion estimation procedures that are utilized in video compression. These procedures are also known as inter-prediction or intra-prediction. In video compression, the next image to be transmitted is broken into a plurality of blocks, which are compressed separately and then transmitted. For each block, a prediction block is identified. The block may be based on a previously transmitted frame or part of the current frame that has already been sent to the receiver. The former case is referred to as inter-prediction, and the later case is referred to an intra-prediction. The block that is chosen is the one that best approximates the block that is currently being coded for transmission. The prediction block can be transmitted to the receiver in a few bits that identify the location of the block in the previous frame or the type of intra-prediction. The prediction block is then subtracted from the current block to produce a residual block that is then compressed using some form of image transformation and quantization procedure. If the prediction block is a good match to the current block, the range of pixel values in the residual block will be much less than the range of pixel values in the current block, and hence, the number of bits that must be transmitted to reconstruct the current block at the receiver to some predetermined accuracy is substantially reduced.

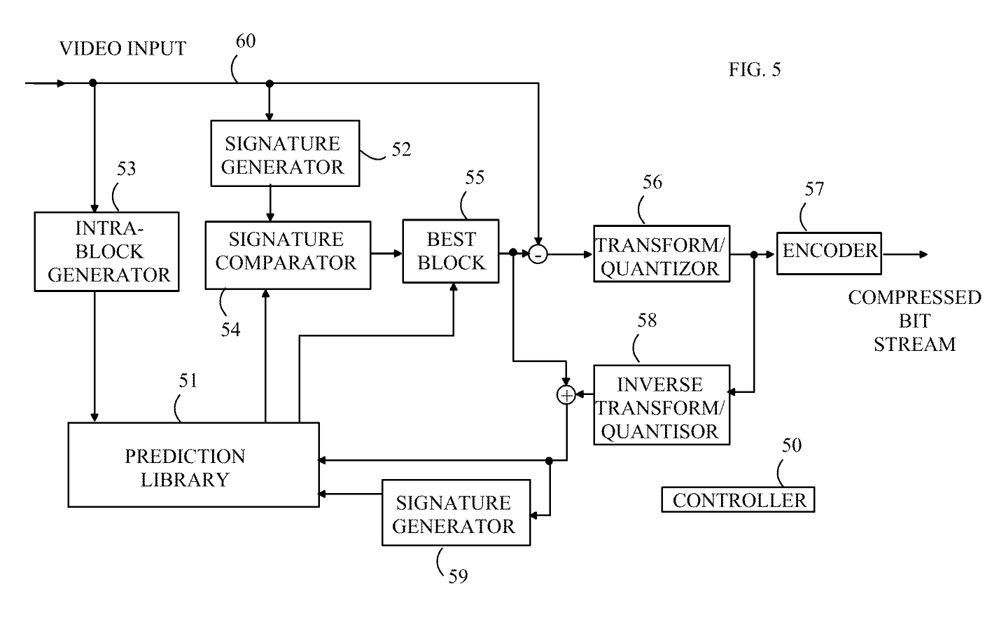

Refer now to FIG. 5, which illustrates a video compression engine according to one embodiment of the present invention. A block of pixels to be encoded for transmission is received on line 60 that provides an input port to the engine. Initially, an intra-block generator generates potential prediction blocks based on the blocks of the current frame that have already been sent and stores these blocks in a prediction block library 51. The prediction block library 51 also includes a previously sent frame for use in generating inter-frame prediction blocks to be used in the encoding operation. A signature vector is generated by signature generator 52 for the current block on line 60. Controller 50 uses signature comparator 54 to compare a signature for each of the blocks in prediction block library 51 to the signature for the current block and selects the block corresponding to the best signature match and places that block in a buffer 55. If intra-prediction is used, the intra-prediction blocks are added to prediction block library 51 by intra-block generator 53 before the start of the comparisons. A residual block is then created by subtracting the block in buffer 55 from the current block. The residual block is then transformed and quantized in a manner analogous to that discussed above by transform/quantizor 56. The output of transform/quantizor 56 is typically encoded using a loss-less encoding scheme such as entropy encoding as shown at 57 prior to being transmitted to the receiver to further reduce the bandwidth needed to send or store the encoded image. Transform/quantizor 56 and coder 57 are conventional components used in an image compressor that relies on comparing blocks rather than comparing signature vectors.

To provide a prediction frame for a subsequent frame, the current block as sent to the receiver is regenerated. The output of transform/quantizor 56 is transformed by inverse transform/quantizor 58 and added to the prediction block to provide a copy of the current block as that block will be regenerated in the receiver. This block is then stored in prediction block library 51 for future use. Optionally, the signature for this block can also be generated and stored in prediction block library 51 by signature generator 59.

To make the comparison between the signature vectors, prediction block library 51 must either include the signature vectors for all possible blocks or the hardware must generate those signature vectors upon request. The number of possible inter-prediction blocks is approximately the same as the number of pixels in the reference frame. As noted above, the signature vector of each current block can be generated by signature generator 59 as that block is coded and stored in prediction block library 51 for future use. However, there are many more potential inter-prediction blocks than the blocks that are coded for transmission, since an inter-prediction block could start on any pixel.

In one aspect of the invention, the signature vector for an inter-prediction block that is not stored in prediction block library 51 is generated the first time the signature vector for that block is requested. The signature vector is then stored for future use. Since each inter-prediction block signature vector will be used multiple times during the encoding of the current frame, the average computational workload for generating these vectors is relatively small. However, the memory needed to store the full complement of signature vectors for the reference frame is approximately Nᵥ times the memory needed to store the reference frame, where Nᵥ is the number of components in each signature vector, and it is assumed that the number of bits/components is substantially the same as the number of bits used for each pixel in the reference frame.

To avoid the additional memory, the signature vector for each potential inter-prediction block could be generated when that block is requested by using an algorithm that does not impose this high memory requirement while still requiring less work to compute than the work to compute the signature vector from the pixels of the reference frame. To simplify the following discussion, the blocks of pixels in an image that coincide with the blocks that are coded during transmission will be referred to as the “encoded” blocks. As noted above, in one aspect of the invention the signature vector for each encoded block in a reference frame is generated by signature generator 59 when that block was encoded for transmission in a previous frame. The number of encoded blocks is a small fraction of the number of potential inter-prediction blocks. For example, if 8×8 blocks are encoded, the number of potential inter-prediction blocks is 64 times the number of encoded blocks. Hence, the memory needed to store the signature vectors for the encoded blocks is much smaller than that needed to store the reference frame.

In one aspect of the invention, the components of the signature vectors are chosen such that the signature vector for a block that starts between the starting locations of the encoded blocks can be approximated by interpolating the signature vectors of the encoded blocks that are closest to that block. In this case, the computational workload is substantially reduced and the storage requirements are also substantially reduced. If the components of the signature vectors are the low-spatial frequency components of an image compression transform such as a wavelet transform, the components will have this property for the correct choice of wavelet transform, since the components are positive weighted sums of blocks of adjacent pixels, and the blocks that start on pixels that are different from the starting pixels of the encoded blocks will still have a significant number of pixels in common with encoded blocks; hence, the transform coefficients will change slowly as a function of the starting location of the block.

It should be noted that the block diagram shown in FIG. 5 could be implemented with special purpose hardware or a general purpose data processing system or a combination of both. The particular blocks are shown to simplify the above discussion. However, the various functions could be incorporated in different blocks or in software running on the controller or a general purpose data processing system.

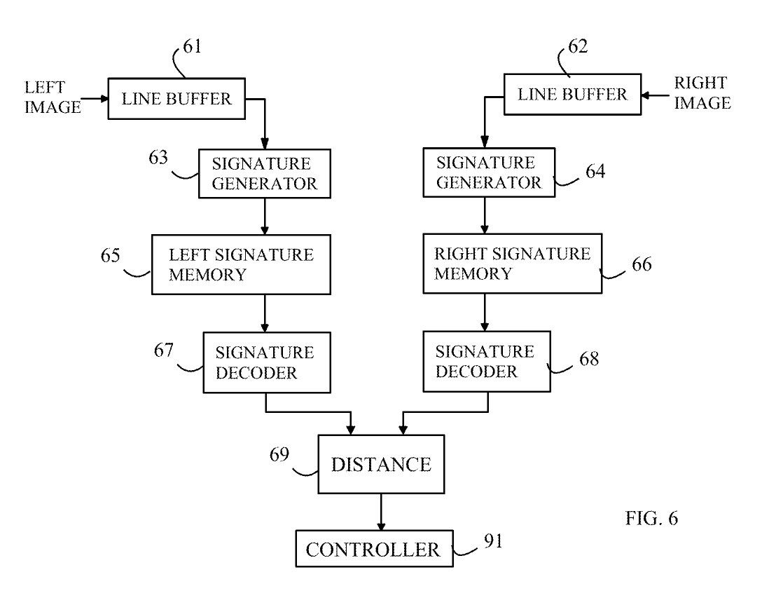

Refer now to FIG. 6, which illustrates an engine for performing stereo disparity matching. For the purposes of the present discussion, the current frame will be referred to as the left image and the reference frame will be referred to as the right image; however, the images could be interchanged. As noted above, in stereo disparity matching, each block centered on a given horizontal line in the left image is matched against each block on the same horizontal line in the right image. Hence, for any given horizontal line through the images, a block of pixels is defined and entered into a corresponding line buffer. The line buffers for the left and right images are shown at 61 and 62, respectively. A signature is generated for each block by a signature generator, the signal generators are shown at 63 and 64. To reduce the space needed to store a signature, the signatures may be encoded prior to being stored in a corresponding signature memory. The signature memory for the left image is shown at 65 and the signature memory for the right image is shown at 66. For example, in the case of vector quantized signals, the label for the signature vector rather than the signature vector itself could be stored in the signature memories. A controller 91 matches a signature from right signature memory 66 with all of the signatures corresponding to blocks on the same horizontal line that are stored in the left signature memory 65. If the signatures have been encoded, a signature decoder generates the actual signal vectors from the decoded forms stored in the signature memories. The signature decoders are shown at 67 and 68. The distance between the signature vectors is then computed using a distance measuring module 69. Controller 91 keeps track of the block from the two images whose signature vectors are closest to one another. In addition, controller 91 also runs the various modules that generate the signatures and store and retrieve those signatures. To simplify the drawings, the connections between controller 91 and the various modules have been omitted.

The present invention can be utilized to improve computational workloads in various image recognition systems. In one class of systems, objects are characterized by a set of “invariant” points in the object. The invariant points are actually blocks of pixels that have been transformed to a standard orientation and scale and then weighted to emphasize the pixels near the center of the block. For each object in the library, the invariant points associated with that object are stored. Given an unknown scene, blocks of pixels within that scene are compared to invariant points in the library after similarly rotating, scaling, and weighting the blocks. A list of blocks that matched is then compared the lists of blocks associated with each object in the library to determine if any of the objects in the library are present in the scene. In terms of the present invention, the reference “frame” is the collection of the blocks in the library. Each block in the current frame is compared with all of the blocks in the library after the block in the current frame has been similarly rotated, scaled, and weighted.

The present invention reduces the workload in making the comparisons. First, a signature can be associated with each block in the reference frame by using an energy concentrating transform on the reference blocks. This computation only needs to be done once and the signatures become part of the library. A signature is then created for each block to be compared in the unknown image after a similar rotation, scaling, and weighting operation. The comparisons can now be carried out by using the signature vectors rather than matching the blocks directly. In this case, the size of the pixel blocks being compared is set by the invariant point library, and are typically much larger than the size of the blocks used in inter-predication. Accordingly, the present invention is particularly well suited for such comparisons.

As noted above, the present invention can be implemented in a variety of hardware embodiments. In general, the present invention is well suited for applications in which each block in a current frame is to be compared with a plurality of blocks in a reference frame to determine the block in the reference frame that most closely matches the block in the current frame. It is useful to differentiate the nomenclature used for the blocks in the current and reference frames. In general, a first block, C₁, of pixels in a current frame is compared to a second block, R₁, of pixels in a reference frame. The apparatus includes a signature processor and a distance measuring processor. The signature processor generates signature vectors from blocks of pixels in either frame. For example, the signature processor generates a first signature vector, VC₁, for the first block and a second signature vector, VR₁, for the second block. The distance measuring processor operates on any two vectors having the same length. The distance measuring processor measures a distance between two vectors V₁ and V₂ using a distance function D(V₁,V₂). The distance function and signature vectors are chosen such that if

D(C₁,R₁)<D(C₁,R₂) then D(VC₁,VR₁)<D(VC₁,VR₂),

where R₂ is a third block of pixels in said reference frame. In addition, computing D(C₁,R₁) imposes a first computational workload, computing D(VC₁,VR₁) imposes a second computational workload, and generating the signature vectors also imposes a third computational workload on the apparatus. The signature vectors and distance functions are chosen such that the sum of the third computational workload and the second computational workload is less than the first computational workload.

The apparatus also includes a controller that compares each of a plurality of blocks of pixels in the reference frame to the first block of pixels by causing the signature processor to generate a reference signature vector corresponding to each of the blocks of pixels in the reference frame and measuring the distance between the reference signature vector corresponding to that block of pixels and VR₁.

As noted above, the apparatus can be included in a number of systems including stereo disparity systems and motion compensation systems for image compression.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A method for operating a data processing system to compare a first block, B₁, of pixels in a current frame to a second block, B₂, of pixels in a reference frame, said method comprising:
generating a first signature vector, V₁, for said first block,
generating a second signature vector, V₂, for said second block, and
measuring a distance between first and second signature vectors using a distance function D(V₁,V₂), wherein the signature vectors and distance function are chosen such that
D(B₁,B₂)<D(B₁,B₃) then D(V₁,V₂)<D(V₁,V₃), where B₃ is a third block of pixels in said reference frame, and
wherein computing D(B₁,B₂) imposes a first computational workload on said data processing system and computing D(V₁,V₂) imposes a second computational workload on said data processing system, and wherein a sum of said computational workload imposed by generating V₁ and V₂ on said data processing and said second computational workload are, on average, less than less than said first computational workload.

2. The method of claim 1 wherein generating said first signature vector comprises transforming said first block using a linear transformation to generate a component of said first signature vector.

3. The method of claim 2 further comprising quantizing said first signature vector to generate a second signature vector.

4. The method of claim 3 wherein said quantizing comprises vector quantization.

5. The method of claim 4 wherein said vector quantization comprises Pyramid Vector Quantization.

6. The method of claim 3 wherein said quantization comprises quantizing each component of said first signature vector separately.

7. The method of claim 3 further comprising coding said second signature vector to reduce the number of bits needed to specify said second signature vector.

8. The method of claim 2 wherein said component measures a power in a portion of said first block in spatial frequencies that are less than a first spatial frequency limit.

9. The method of claim 2 wherein said component measures a power in a portion of said first block in spatial frequencies in a first spatial frequency band having a low-spatial frequency cut-off greater than zero.

10. The method of claim 2 wherein said linear transformation is a wavelet transformation.

11. The method of claim 10 wherein said wavelet transformation is a Haar transformation.

12. The method of claim 1 further comprising generating a third signature vector, V₃, for a third block in said reference frame, said third signature vector being generated by updating said second signature vector, and comparing said distance between said first and third signature vectors with said distance between said first and second signature vectors.

13. The method of claim 12 wherein said reference frame comprises a plurality of rows and columns of pixels and wherein said third block is located on the same row of said reference frame as said second block and has pixels in common with said second block.

14. The method of claim 12 wherein said reference frame comprises a plurality of rows and columns of pixels and wherein said third block is located on the same column of said reference frame as said second block and has pixels in common with said second block.

15. The method of claim 1 further comprising generating a plurality of signature vectors corresponding to different blocks of pixels in said reference frame, each block of pixels in said reference frame and said block in said current frame being characterized by a number of pixels, said number of pixels in said blocks in said reference frame being equal to said number of pixels in said first block;
measuring a distance between each of said signature vectors corresponding to said blocks in said reference and said first signature vector; and
identifying which block in said reference has a signature vector that is closest to said first signature vector.

16. An apparatus that compares a first block, C₁, of pixels in a current frame to a second block, R₁, of pixels in a reference frame, said apparatus comprising:
a signature processor that generates signature vectors from blocks of pixels, said signature processor generating a first signature vector, VC₁, for said first block and a second signature vector, VR₁, for said second block, and
a distance measuring processor that measures a distance between two vectors V₁ and V₂ using a distance function D(V₁,V₂), wherein if
D(C₁,R₁)<D(C₁,R₂) then D(VC₁,VR₁)<D(VC₁,VR₂), where R₂ is a third block of pixels in said reference frame, and
wherein computing D(C₁,R₁) imposes a first computational workload and computing D(VC₁,VR₁) imposes a second computational workload, and wherein a sum of said computational workload imposed by generating VC₁ and VR₁ and said second computational workload are less than said first computational workload.

17. The apparatus of claim 16 further comprising a controller that compares each of a plurality of blocks of pixels in said reference frame to said first block of pixels by causing said signature processor to generate a reference signature vector corresponding to each of said blocks of pixels in said reference frame and measuring said distance between said reference signature vector corresponding to that block of pixels and VR₁.

18. The apparatus of claim 16 wherein said signature processor generates said signature for a block of pixels by transforming said first block using a linear transformation to generate a component of said signature vector.

19. The apparatus of claim 18 wherein said component measures a power in a portion of said block of pixels in spatial frequencies that are less than a first spatial frequency limit.

20. The apparatus of claim 18 wherein said linear transformation is a wavelet transformation.

21. The apparatus of claim 20 wherein said wavelet transformation is a Haar transformation.

22. The apparatus of claim 17 wherein said signature processor generates a signature vector for one of said blocks of pixels in either said current frame or said reference frame by updating a signature vector that has been generated for another block of pixels in said current frame or reference frame, respectively, rather than generating said signature vector solely from said pixels in that block.

23. The apparatus of claim 17 wherein said signature processor generates said signature vector by interpolating a plurality of signature vectors that have already been generated.

24. An apparatus comprising:
a port that receives a block of pixels from a current frame that is to be compressed;
a signature generator that generates a current signature vector from said received block of pixels;
a library that includes a plurality of blocks of pixels from a reference frame, said library including a plurality library signature vectors, one such library signature vector corresponding to each of said plurality of blocks of pixels in said library; and
a controller that selects a matching block of pixels from said library by measuring a distance between each signature in said library and said current signature vector using a distance function, said matching block of pixels being said block of pixels in said library for which said signature vector is closest to said current signature vector as measured by said distance function, wherein said signature generator and said distance function are chosen such that the computational workload imposed by matching signature vectors is less than the computational workload that would have been imposed by matching said one of said received blocks and each of said blocks in said library using said distance function.

25. The apparatus of claim 24 further comprising a compression processor that encodes said received block of pixels using said matching block of pixels, said encoded block of pixels comprising information specifying said matching block of pixels.
